(19) United States
(12) Patent Application Publication
(10) Pub. No.: US 2008/0068472 A1
(43) Pub. Date: Mar. 20, 2008

(54) DIGITAL CAMERA AND METHOD

(75) Inventor: Jianping Zhou, Richardson, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/854,994

(22) Filed: Sep. 13, 2007

Related U.S. Application Data
(60) Provisional application No. 60/825,749, filed on Sep. 15, 2006.

(51) Int. Cl. H04N 9/68

(52) U.S. Cl. 348/236; 382/274

(57) ABSTRACT

Adaptive brightness enhancement of digital camera images constructs tone mapping from increment high and decrement low occupancy levels' differentials.

### CROSS-REFERENCE TO RELATED APPLICATIONS

This application claims priority from provisional patent application No. 60/825,749, filed Sep. 15, 2006. The following co-assigned copending patent applications disclose related subject matter: Ser. No. 11/741,753, filed Apr. 29, 2007 and Ser. No. 11/751,080, filed May 21, 2007.

### BACKGROUND OF THE INVENTION

The present invention relates to digital video signal processing, and more particularly to architectures and methods for digital cameras.

Imaging and video capabilities have become the trend in consumer electronics. Digital cameras, digital camcorders, and video cellular phones are common, and many other new gadgets are evolving in the market. Advances in large resolution CCD/CMOS sensors coupled with the availability of low-power digital signal processors (DSPs) has led to the development of digital cameras with both high resolution image and short audio/visual clip capabilities. The high resolution (e.g., sensor with a 2560×1920 pixel array) provides quality offered by traditional film cameras.

FIGS. 3A-3B show typical functional blocks for digital camera control and image processing (the “image pipeline”). The automatic focus, automatic exposure, and automatic white balancing are referred to as the 3A functions; and the image processing includes functions such as color filter array (CFA) interpolation, gamma correction, white balancing, color space conversion, and JPEG/MPEG compression/decompression (JPEG for single images and MPEG for video clips). Note that the typical color CCD consists of a rectangular array of photosites (pixels) with each photosite covered by a color filter (the CFA): usually, red, green, or blue. In the commonly-used Bayer pattern CFA one-half of the photosites are green, one-quarter are red, and one-quarter are blue.

Typical digital cameras provide a capture mode with full resolution image or audio/visual clip processing plus compression and storage, a preview mode with lower resolution processing for immediate display, and a playback mode for displaying stored images or audio/visual clips.

However, there often exists a discrepancy between shadow regions in images and the direct human observation of such shadow regions in natural scenes. The human visual system allows one to observe details in natural scenes across a wide range of lighting variations. In contrast, images of natural scenes captured by digital cameras suffer from a loss of detail, especially in low-light and shadow regions. For a discussion, see V. Brajovic, “Brightness Perception, Dynamic Range, and Noise: a Uniform Model for Adaptive Image Sensors”, IEEE Conf. Computer Vision and Pattern Recognition, Vol. 2, pp. 189-196, 2004; and D. Jobson et al. “A Multiscale Retinex for Bridging the Gap between Color Images and the Human Observation of Scenes”, IEEE Trans. Image Processing, Vol. 6, No. 7, July 1997.

Nature scenes have high dynamic ranges and human eyes can adapt to light variation automatically. But due to the limitations of sensors, image processors, and displays, digital cameras or camera phones have very limited dynamic ranges, which results in shadows or highlights in digital images. Many brightness enhancement methods have been proposed in image processing applications. However, they are too complex to be used for digital cameras. A desirable method for digital cameras should be universal, because digital cameras will be used to capture different kinds of images. It also should have low computation complexity and low memory requirements, due to the cost and shot-to-shot constraints of digital cameras.

### SUMMARY OF THE INVENTION

The present invention provides digital image brightness enhancement with tone scaling adapted to the image by histogram occupancy levels.

### BRIEF DESCRIPTION OF THE DRAWINGS

FIG. 1 is a flowchart.

FIGS. 2A-2B show experimental results.

FIGS. 3A-3D illustrate digital cameras and network communication.

### DESCRIPTION OF THE PREFERRED EMBODIMENTS

### 1. Overview

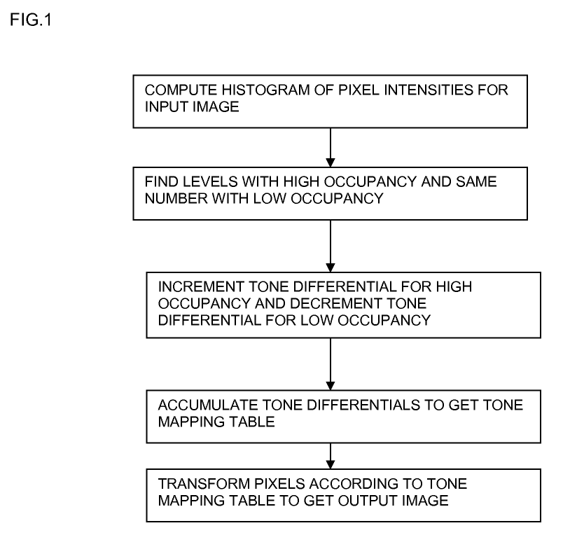

Preferred embodiments provide adaptive brightness enhancement methods with the most-occupied and the least-occupied levels of the pixel value histogram incrementing and decrementing a tone mapping. FIG. 1 is a flowchart.

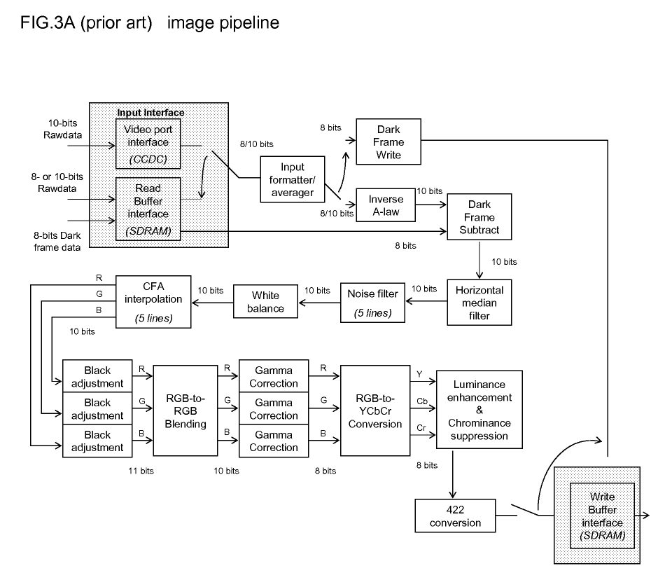

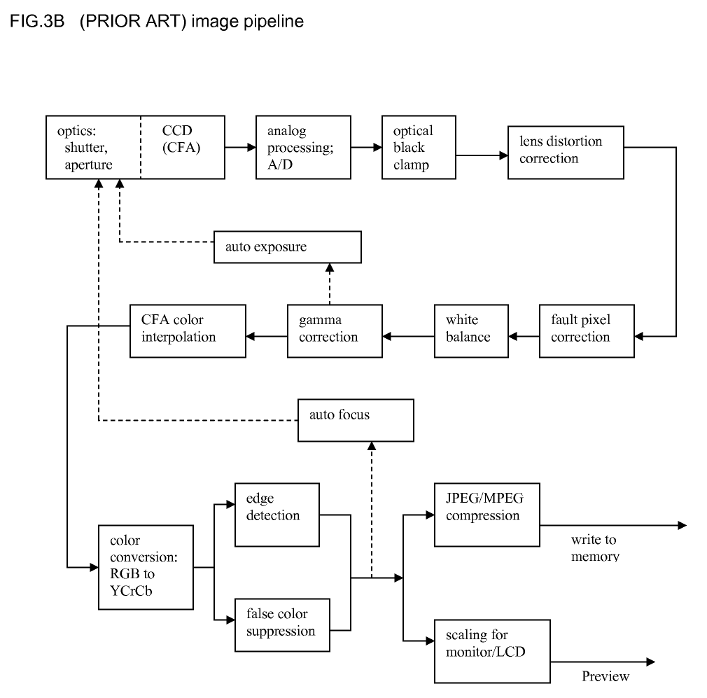

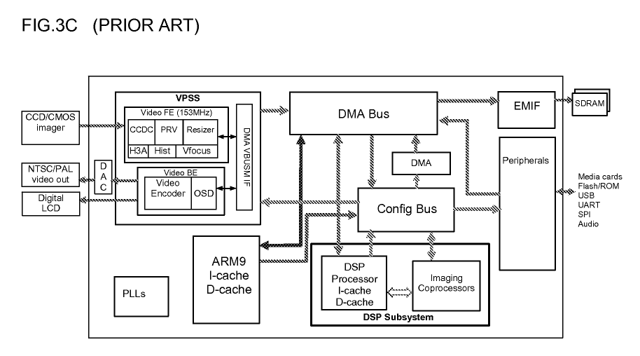

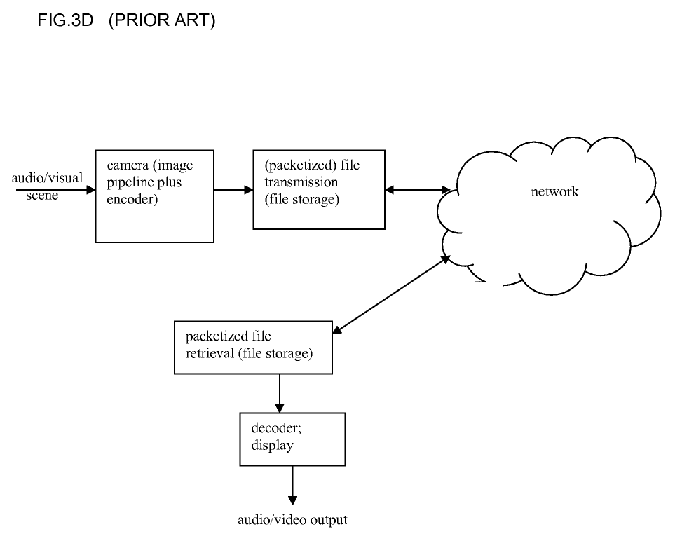

Preferred embodiment systems (e.g., digital cameras, camera cellphones, PDAs, etc.) perform preferred embodiment methods with any of several types of hardware: digital signal processors (DSPs), general purpose programmable processors, application specific circuits, or systems on a chip (SoC) such as combinations of a DSP and a RISC processor together with various specialized programmable accelerators. FIG. 3C is an example of digital camera hardware. A stored program in an onboard or external (flash EEP)ROM or FRAM could provide implementation of the signal processing methods. Analog-to-digital converters and digital-to-analog converters can provide coupling to the real world, modulators and demodulators (plus antennas for air interfaces) can provide coupling for transmission waveforms, and packetizers can provide formats for transmission over networks such as the Internet; see FIG. 3D.

Preferred embodiment methods enhance the details and illumination level in shadow and low-light regions in images, while preserving the details and lighting in well-lit regions by use of an adaptive tone scaling to have:
a) very low computation complexity.
b) very low memory requirements.
c) works for both gray and color images.
d) can be easily implemented on existing hardware image processors.

### 2. Adaptive Brightness Enhancement Preferred Embodiments

The first preferred embodiment methods of image brightness enhancement use tone mapping. The intensity level of each pixel will be mapped (transformed) to a new level based on a given tone mapping table. Tone mapping provides for simple implementation. The transform can be performed either before or after the Gamma correction (see FIGS. 3A-3B). To achieve universal brightness enhancement, the specific tone mapping table is image dependent. To keep color information, the tone mapping is applied to the luminance component of each pixel. Second preferred embodiment methods apply a common tone mapping table to each of the R, G, and B component levels (values) of the pixels.

The preferred embodiment methods generate a tone mapping table based on the image characteristic. First, note that Rec709 provides the luminance level (Y) of each color pixel to be computed as:

Y=0.2125R+0.7154G+0.0721B

Because the green component contributes the most energy to the luminance, for low complexity the first preferred embodiment methods use the green component only; that is, transform G rather than Y. Experiments also show that this simplification does not introduce visible differences.

Next, use histogram analysis (occupancy of the G levels/bins) to determine the tone mapping table by the follow steps.
(1) For an input image, compute the histogram of the green (or luminance if gray scale or Y has already been computed) component with 256 levels (bins). For example, a 2 megapixel image with a uniform distribution of green/luminance levels, would have an average level occupancy of about 8000 pixels.
(2) Initialize a tone difference table:

toneDiff(k)=1 for k=1, 2, . . . , 255.
(3) Compute the cutoff number nC=3*nP/256, where nP is the number of pixels in the image. Thus for the example 2 megapixel image, nC 24000.
(4) Find the set of green (luminance) levels {Sᵢ} such that the number of pixels with green (luminance) level equal to Sᵢ is larger than nC. That is, the {Sᵢ} are the highly occupied levels and form a subset of {1, 2, . . . , 255}. Denote the number of such Sᵢ by N. Update the tone difference table at these levels.

toneDiff(Sᵢ)=2 for i=1, 2, . . . , N.
(5) Find the N least occupied levels {Sⱼ}. Update the tone difference table at these levels; these decrements compensate for the increments of preceding step 4. If there are multiple levels with the same occupancy, then any subset selection (e.g., random) can be used to get exactly N least occupied levels.

toneDiff(Sⱼ)=0 for j=1, 2, . . . , N.
(6) Compute the tone mapping table by summing the tone difference table.

tone(0)=0

tone(k)=tone(k 1)+toneDiff(k) for k=1, 2, . . . , 255.

If the green (luminance) level of the input image is 8-bit, such as 8-bit gray scale or 24-bit RGB color, apply this tone table directly because there are only 256 levels. That is, if a pixel has level k, change its level to tone(k). If the levels of the input image pixels are more than 8 bits, for example, 12 bits, generate an interpolated tone table from the 256-tone table. The interpolation could be simple linear interpolation.

### 3. Histogram

The main complexity of the preferred embodiment method is histogram computation. A straightforward way to do the histogram computation is after the RGB-to-RGB color level conversion (see FIG. 3A) which uses previously-evaluated sensor-dependent parameters M_{i,j} and Oⱼ:

$$[ \begin{matrix}{R}^{′} \\ {G}^{′} \\ {B}^{′}\end{matrix} ] = [ \begin{matrix}{M}_{11} & {M}_{12} & {M}_{13} \\ {M}_{21} & {M}_{22} & {M}_{23} \\ {M}_{31} & {M}_{32} & {M}_{33}\end{matrix} ] [ \begin{matrix}R \\ G \\ B\end{matrix} ] + [ \begin{matrix}{O}_{1} \\ {O}_{2} \\ {O}_{3}\end{matrix} ]$$

However, since an image is processed by all ISP functions row by row, it requires two passes of ISP processing. There are two ways to lower complexity. One way is to compute the histogram using downsampled data from the preview engine (e.g., upper left portion of FIG. 3C).

Another way is to perform the histogram computation before the ISP processing. The difficulty is how to estimate the histogram of processed green components based on the raw Bayer data (i.e., prior to Gr-Gb balance and RGB-to-RGB conversion). Note that the processed G component typically differs from Gr and Gb components of the raw Bayer data. The preferred embodiment methods use a simplified model for the pipeline processing and estimate downsampled processed green components as a linear combination of R, Gr, Gb, and B in a 2×2 neighbor of Bayer raw data as follows:

G=(W_{R}M_{2,1}R+W_{G}M_{2,2}Gr/2+W_{G}M_{2,2}Gb/2+W_{B}M_{2,3}B)D+O₂

where D is the digital gain, Wi are white balancing gains, M_{2,i} and O₂ are RGB-to-RGB conversion coefficients for the processed green component. Note that the digital gain and white balancing gains are provided by auto exposure and auto white balance functions of the image pipeline.

### 4. Experimental Results

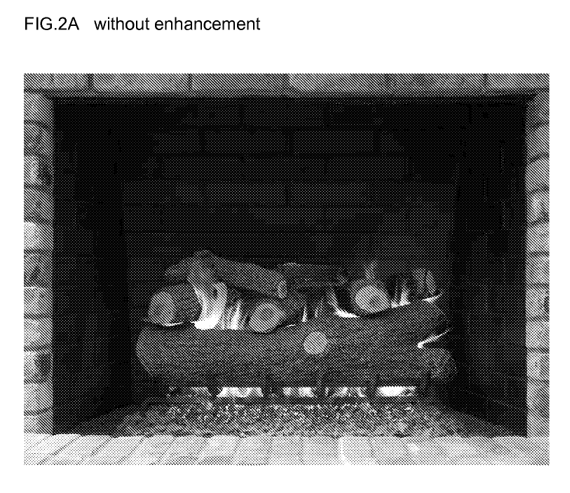

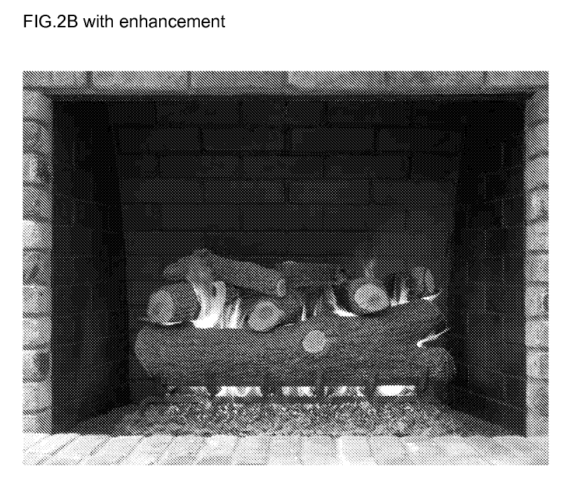

We show an example of brightness enhancement in FIGS. 2A-2B. The FIG. 2A image is before brightness enhancement and FIG. 2B is after the first preferred embodiment brightness enhancement method.

### 5. Modifications

The preferred embodiments can be modified in various ways, such as the number of levels in the initial tone mapping could be greater than or less than 256; the raw data could be from a non-Bayer array such as a complementary color array. If cameras with complementary color array provide CMYG (Cyan, Magenta, Yellow, and Green) to RGB conversion in CCDC, we can use the same formulas to compute green or luminance components. Otherwise, we can use the foregoing formulas to convert CMYG to RGB,

R=−0.4286*C+0.5714*M+0.4286*Y−0.1429*G′

G=0.2857*C+0.2857*M−0.2857*Y+0.4286*G′

B=0.5714*C−0.4286*M+0.4286*Y−0.1429*G′

where G′ represents green in CMYG.

What is claimed is:

1. An image brightness enhancement method, comprising the steps of:
(a) providing a histogram of L levels for the pixels of an input image where L is a positive integer;
(b) finding N most-occupied of said L levels and N least-occupied of said L levels where N is a positive integer;
(c) computing a tone mapping table by incrementing a tone differential at said N most-occupied levels and decrementing said tone differential at said N least-occupied levels; and
(d) mapping said pixel levels of said input image using said tone mapping table.

2. The method of claim 1, wherein said levels are the green values of said pixels.

3. The method of claim 2, wherein said green values are estimated from a linear combination of color sensor outputs.

4. The method of claim 1, wherein said levels are the luminance values of said pixels.

5. The method of claim 1, wherein said integer L equals 256.

6. The method of claim 1, wherein said integer N is determined as the number of said levels with occupancy exceeding a fraction of the total number of pixels in said image where said fraction is less than 1.

7. The method of claim 6, wherein said fraction equals 3 divided by L.

8. A digital camera, comprising:
(i) a sensor;
(ii) an image pipeline coupled to said sensor, said image pipeline including a brightness enhancement function operable to:
(a) provide a histogram of L levels for the pixels of an input image where L is a positive integer;
(b) find N most-occupied of said L levels and N least-occupied of said L levels where N is a positive integer;
(c) compute a tone mapping table by incrementing a tone differential at said N most-occupied levels and decrementing said tone differential at said N least-occupied levels; and
(d) map said pixel levels of said input image using said tone mapping table.

9. The camera of claim 8, wherein said levels are the green values of said pixels.

10. The camera of claim 9, wherein said green values are estimated from a linear combination of color outputs of said sensor.

11. The camera of claim 8, wherein said levels are the luminance values of said pixels.

12. The cameral of claim 8, wherein said integer L equals 256.

13. The camera of claim 8, wherein said integer N is determined as the number of said levels with occupancy exceeding a fraction of the total number of pixels in said image where said fraction is less than 1.

14. The camera of claim 13, wherein said fraction equals 3 divided by L.
